(19) United States
(12) Patent Application Publication
(10) Pub. No.: US 2010/0182581 A1
(43) Pub. Date: Jul. 22, 2010

(54) LENS, EXPOSURE APPARATUS, AND DEVICE MANUFACTURING METHOD

(75) Inventor: Nobuto Kawahara, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/688,195

(22) Filed: Jan. 15, 2010

(30) Foreign Application Priority Data
Jan. 20, 2009 (JP) 2009-009581

(51) Int. Cl. G03B 27/54

(52) U.S. Cl. 355/67; 359/642

(57) ABSTRACT

A lens 10 is used in a state where a direction of an optical axis 1b passing through a curvature center of a lens surface is different from a direction of a gravitational force, and a position of a center 1a of a light beam effective portion 3 (a position of the optical axis on the lens surface) is displaced (is eccentric) from a position of an outside diameter center 2a of the lens 10 (a center position of a lens outside diameter). Specifically, the center 1a of the light beam effective portion 3 is positioned at an upper side by a distance β from the outside diameter center 2a of the lens 10.

### BACKGROUND OF THE INVENTION

1. Field of the Invention

The present invention relates to a lens, and more particularly to a lens which is used in a state where a direction of an optical axis passing through a curvature center of a lens surface is different from a direction of a gravitational force.

2. Description of the Related Art

Previously, when manufacturing a device such as a semiconductor device or a liquid crystal display device, a projection exposure apparatus which transfers a pattern formed on a mask onto a substrate to which a resist is applied has been used. Recently, the miniaturization of the semiconductor device is proceeding, and a pattern having a line width equal to or less than 0.15 μm is transferred. In order to realize a further miniaturization, the resolution of the exposure apparatus needs to be improved. For the reasons above, previously, the numerical aperture NA of the projection optical system has increased and the exposure light wavelength has been shortened.

However, when the numerical aperture NA has increased, the problem that lights constituted by P-polarized lights, which have an electric field vector in a direction of a plane including a light beam and a vertical line of the substrate when entering the substrate, reduce a contrast of an interference pattern may occur. Therefore, in order to increase the numerical aperture NA to improve the resolution, a polarized illumination illuminating a mask with only S-polarized light, which is light having an electric field vector perpendicular to that of the P-polarized light, removing the P-polarized light, along with increasing the numerical aperture NA needs to be realized.

Previously, the exposure apparatus has used an optical element made of a material of calcium fluoride (CaF₂) which has a high transmittance of short wavelength light and has high optical characteristics such as refractive index homogeneity. Calcium fluoride indicates a birefringence for a stress, and its optical characteristics are deteriorated if there is a residual stress. Therefore, for example, the residual stress inside the optical element needs to be reduced by a heat treatment or the stress distribution needs to be generated by applying a pressure to the optical element in order to correct the birefringence.

Japanese Patent Laid-open No. 2004-214454 discloses a lens barrel in which lens holding members are arranged in a radial fashion at an outer circumference portion of a lens. An elastic member is bonded to each of the lens holding members so that a desired pressure is applied from an outer circumferential direction of the lens.

Japanese Patent Laid-open No. 2003-29116 discloses a structure of a clearance groove provided in a lens holding member which holds a lens. Thus, the distortion caused by fixing an external barrel to the lens holding member is not transferred to the lens in order to prevent applying the external force to the lens.

Japanese Patent No. 3956454 discloses a lens supporting apparatus which is configured to contact a lens with three small lens contact surfaces to prevent applying the external force to the lens.

However, in the lens barrel disclosed in Japanese Patent Laid-open Nos. 2004-214454 and 2003-29116 and Japanese Patent No. 3956454, when an optical axis direction of the lens is arranged so as to be different from a direction of the gravitational force, the stress caused by its own weight can not be dispersed.

On the other hand, a large-bore lens which includes a polarization break influencing region at the lower side of the lens along with a necessary light beam effective diameter needs to be used in order to use a region where the polarization break is not influenced in the distribution of such polarization break as a light beam effective range. However, when the bore of the lens is large, the range of the polarization break generated at the lower side of the lens is enlarged by its own weight and the bore of the lens is increased.

### BRIEF SUMMARY OF THE INVENTION

The present invention provides a reliable lens which suppresses a deterioration of the optical performance.

A lens as one aspect of the present invention comprises a lens surface having a predetermined curvature. The lens is configured to be used in a state where a direction of an optical axis passing through a curvature center of the lens surface is different from a direction of a gravitational force, and a position of the optical axis on the lens surface is displaced from a center position of a lens outside diameter on the lens surface.

An exposure apparatus as another aspect of the present invention is configured to expose a pattern of an original plate onto a substrate. The exposure apparatus comprises an illumination optical system configured to illuminate the original plate using light from a light source, and a projection optical system configured to project the pattern of the original plate onto the substrate. The illumination optical system includes a lens which is arranged so that a direction of an optical axis passing through a curvature center of a lens surface is different from a direction of a gravitational force, and a position of the optical axis on the lens surface is displaced in a direction different from the direction of the gravitational force from a center position of a lens outside diameter on the lens surface.

A device manufacturing method as another aspect of the present invention comprises the steps of exposing a substrate using the exposure apparatus, and developing the exposed substrate.

Further features and aspects of the present invention will become apparent from the following description of exemplary embodiments with reference to the attached drawings.

### BRIEF DESCRIPTION OF THE DRAWINGS

FIG. 1 is an explanatory diagram of a lens in the present embodiment.

FIG. 2 is an explanatory diagram of a lens in the present embodiment.

FIG. 3 is a schematic configuration diagram of an exposure apparatus in the present embodiment.

FIG. 4 is an explanatory diagram of a polarization generation state of an optical element in the present embodiment.

FIG. 5 is a schematic cross-sectional diagram of a lens barrel whose lens outer circumference is adhesively fixed in the present embodiment.

FIG. 6 is an explanatory diagram of a method of holding an optical element in a barrel in the present embodiment.

FIG. 7 is a schematic cross-sectional diagram of a lens where a step process has been performed for a lens outer circumference in the present embodiment.

FIG. 8 is a schematic cross-sectional diagram of a case where a plurality of lenses are arranged in a lens barrel in the present embodiment.

### DETAILED DESCRIPTION OF THE PREFERRED EMBODIMENTS

Exemplary embodiments of the present invention will be described below with reference to the accompanied drawings. In each of the drawings, the same elements will be denoted by the same reference numerals and the duplicate descriptions thereof will be omitted.

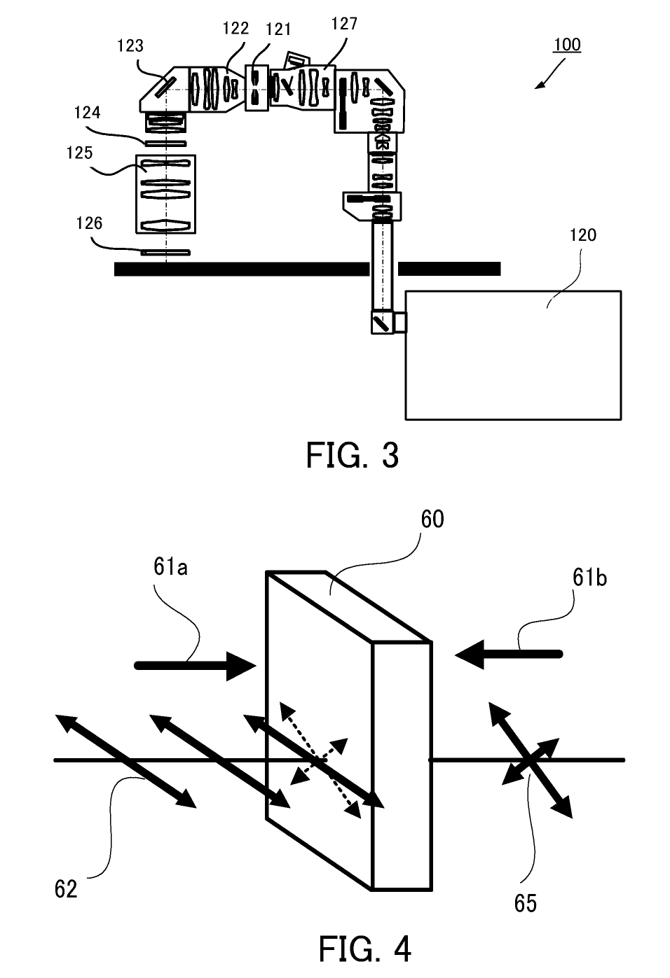

First, an exposure apparatus in the present embodiment will be described. FIG. 3 is a schematic configuration diagram of the exposure apparatus in the present embodiment.

An exposure apparatus 100 is configured to expose a pattern of a mask 124 (an original plate) onto a wafer 126 (a substrate). The exposure apparatus 100 includes an illumination optical system which illuminates the mask 124 using light (illumination light) from a light source such as a laser 120 generating a wavelength of an ultraviolet range. In addition, the exposure apparatus 100 includes a projection optical system (a projection lens 125) which projects the pattern of the mask 124 onto the wafer 126.

The laser 120 (the light source) may include a KrF excimer laser (a wavelength of 248 nm), an ArF excimer laser (a wavelength of 193 nm), an F2 laser (a wavelength of 157 nm), or the like. An exposure light emitted from the laser 120 passes through an optical system in the exposure apparatus 100. For example, an averaging process of an illuminance in a valid range is performed for the exposure light by the optical element such as a micro lens array (not shown) or an optical integrator, or a computer generated hologram (not shown) is performed for the exposure light. After the exposure light forms a desired Fourier transform image, it is imaged at a movable blind 121 by using a condenser lens 127.

After the exposure light transmitted through the movable blind 121 passes through a condenser lens 122, it is imaged again on the mask 124 via a mirror 123. The movable blind 121 includes a Fourier transform plane of the optical integrator, and is arranged at an optically conjugate position with the mask 124. Therefore, an opening shape of the movable blind 121 is adjusted using an adjustor (not shown) to be able to limit an exposure light illumination region on the mask 124.

When the exposure apparatus 100 includes a polarized illumination optical system, the exposure light emitted from the laser 120 is converted into polarized light having a polarization state where an electric field vector faces a predetermined direction by using a λ/2 phase plate (not shown) made of a birefringent glass material such as crystal or magnesium fluoride. The λ/2 phase plate is configured so as to be movable. The λ/2 phase plate is moved by using a drive unit (not shown) to be able to switch modes of illuminating a plane to be illuminated using X-polarized light and Y-polarized light. In the embodiment, the X-polarized light is a mode of illuminating the original plate using linearly polarized light having an electric field vector in an X direction of the exposure apparatus 100, and the Y-polarized light is a mode of illuminating the original plate using linearly polarized light having an electric field vector in a Y direction of the exposure apparatus 100.

Thus, in the exposure apparatus including the polarized illumination optical system, the polarized light of the exposure light is maintained so as to be in a desired state to ensure an exposure performance. In this case, when the exposure light passes through the optical system, the change of a polarization performance caused by the lens needs to be greatly suppressed.

In a case where the lens is held in the barrel of the exposure apparatus 100, when the lens is arranged so that a direction of an optical axis passing through a center of curvature of the lens is the same as that of the gravitational force, a distortion caused by its own weight is generated substantially symmetrical with respect to the optical axis. However, it is difficult to arrange all optical systems on the same optical axis. Therefore, in the exposure apparatus 100 of the present embodiment, a part of lenses such as condenser lenses 122 and 127 are arranged so that their optical axes are vertical to the direction of the gravitational force. Thus, in a lens arranged so that its optical axis direction is different from that of the gravitational force, a polarization break is generated by its own weight.

In the illumination optical system of the exposure apparatus, a fly-eye lens is arranged between the condenser lens 122 and the condenser lens 127. The fly-eye lens is provided to be able to obtain an averaging effect which averages the exposure light. Thus, in the present embodiment, especially, the condenser lens 122 which is arranged at an image side (at a latter side) with reference to the fly-eye lens is preferably configured as an eccentric lens.

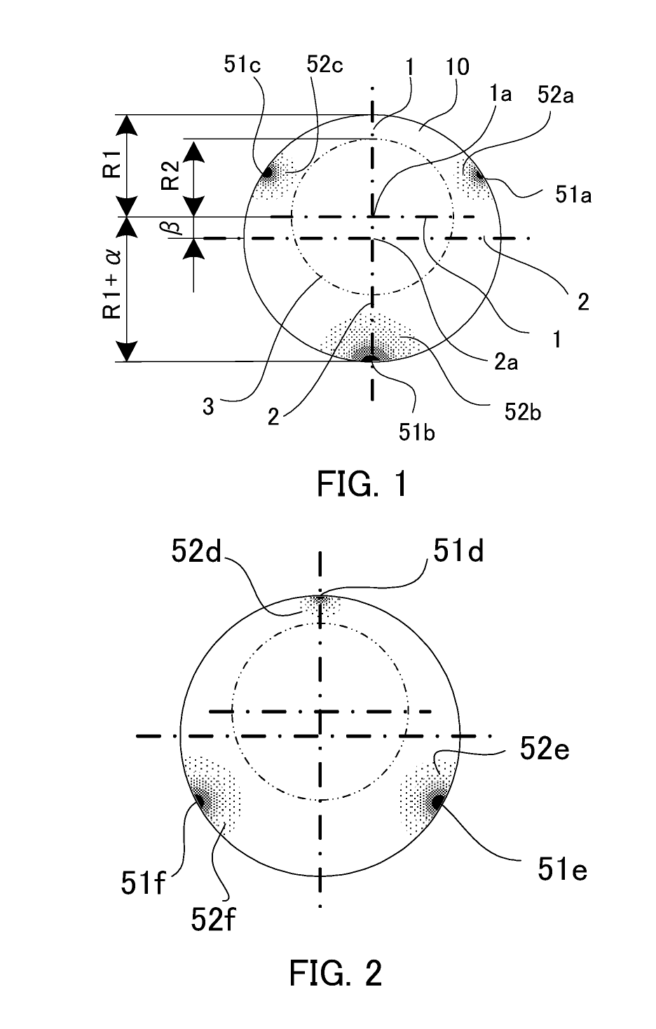

Next, referring to FIGS. 1 and 2, the relationship between the arrangement of the lens and the polarization break will be described. FIGS. 1 and 2 show cases where the lens is positioned so that its optical axis direction is vertical to the direction of the gravitational force.

In FIG. 1, the lens 10 is held by three holders (holding points 51a to 51c) around the outer circumference of the lens 10. Therefore, in the vicinity of the holding points 51a and 51c, the polarization breaks 52a and 52c are respectively generated by the three holders. In the vicinity of the holding point 51b at the lower part of the lens 10, the polarization break 52b which is larger than each of the polarization breaks 52a and 52c is generated by the own weight of the lens.

FIG. 2 shows a case where the barrel is rotated around the optical axis and positions of the three holders are displaced in a circumferential direction of the lens 10. In other words, the positions of the holders 51a to 51c are changed to holding points 51d to 51f, respectively. As shown in FIG. 2, even when the three holders are displaced, a large polarization breaks 52e and 52f are generated in the vicinity of the holding points 51f and 51e at the lower part of the lens 10.

In FIG. 1, reference numeral 2 denotes a center line of the lens 10, and an intersection point of the two center lines 2 is an outside diameter center 2a of the lens 10. Reference numeral 3 denotes a light beam effective portion of the lens 10. The light beam effective portion 3 indicates a circle region of the radius R2 capable of using the light beam which enters the lens 10. Reference numeral 1 denotes a center line of the light beam effective portion 3, and the intersection point of the two center lines 1 is a center 1a of the light beam effective portion 3.

As shown in FIG. 1, the position of the center 1a of the light beam effective portion 3 (the position of the optical axis on the lens surface) is displaced (is eccentric) from a position of an outside diameter center 2a of the lens (a center position of the lens outside diameter). Specifically, the center 1a of the light beam effective portion 3 is positioned at the upper side by a distance β with reference to the diameter center 2a of the lens 10. Therefore, a distance R1+α between the center 1a of the light beam effective portion 3 and the lower end of the lens 10 is larger than a distance R1 between the center 1a of the light beam effective portion 3 and the upper end of the lens 10. Thus, when the position of the center 1a of the light beam effective portion 3 is displaced, the influence of the polarization break for the light beam effective portion 3 as described above can be suppressed.

In the present embodiment, an eccentric process is performed for the lens 10 so that the position of the center 1a of the light beam effective portion 3 is coincident with the position of the optical axis on the lens surface. The optical axis means an axis that is formed by connecting curvature centers of two lens surfaces (an axis passing through curvature centers of the lens surface). In other words, when the lens 10 is a convex lens, the position of the optical axis on the lens surface is a position where the lens 10 is the thickest on the lens surface in the optical axis direction. On the other hand, when the lens 10 is a concave lens, the position of the optical axis on the lens surface is a position where the lens 10 is the thinnest on the lens surface in the optical axis direction.

In the present embodiment, the outside diameter of the lens barrel has a substantially cylindrical shape. However, in accordance with the shape of the lens 10 as an eccentric lens, the position of the optical axis of the lens 10 and the position of the center axis of the barrel are displaced by distance β from each other.

FIG. 6 is a schematic cross-sectional diagram of the lens 10 in the present embodiment. As shown in FIG. 6, an eccentric process is performed for the lens 10 so that an optical axis 1b is positioned at the upper side with reference to the outside diameter center of the lens 10. The holder at the outer circumference of the lens 10 (a lens barrel 11) is provided with a gap filling material 15. The gap filling material 15 has a thickness differing in accordance with its location so as to fit a shape of the lens for which the eccentric process has been performed. The lens 10 is pressed at a constant load using an elastic member such as a spring 17 from an opposite side of the gap filling member 15.

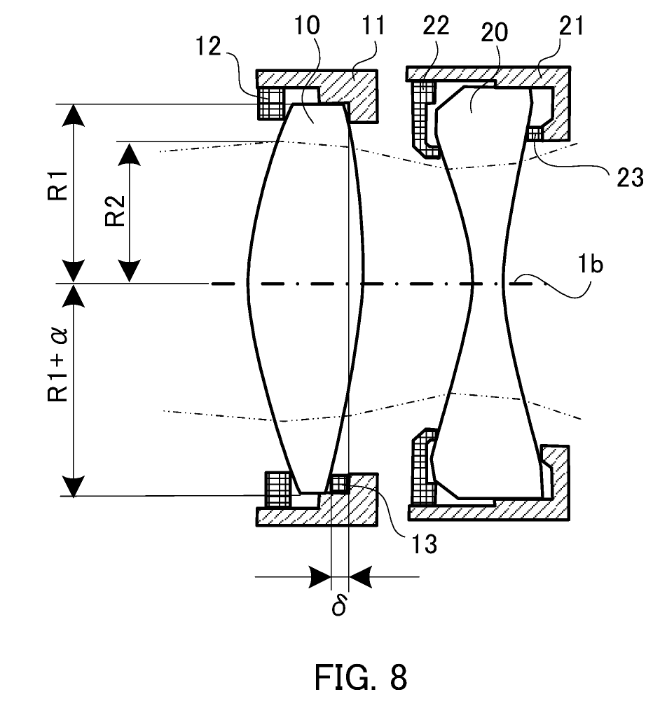

FIG. 8 is a schematic cross-sectional diagram of a case where a plurality of lens (lens group) are arranged in the lens barrel.

When a direction of the optical axis 1b of the lens group (lenses 10 and 20) is vertical to the direction of the gravitational force, for the convex lens (the lens 10), a region having a diameter larger than the radius R2 of the light beam effective portion 3 of the lens 10 is held between the lens barrel 11 and the lens holder 12 so that the lens 10 is fixed. Similarly, also for the concave lens (the lens 20), a region having a diameter larger than the light beam effective portion of the lens 20 is held between a lens barrel 21 and a lens holder 22 so that the lens 20 is fixed.

However, in the lens barrel of the present embodiment, the lenses 10 and 20 that are objects to be fixed also have eccentric structures. Therefore, the upper part of the lenses 10 and 20 and the lower part of the lenses 10 and 20 are respectively different in thickness of the lenses 10 and 20 in a direction of the optical axis 1b. Therefore, as a common lens barrel, the lenses 10 and 20 can not be fixed at a uniform thickness in a circumferential direction of the respective lenses.

Referring to the lens 10 (the convex lens) of FIG. 8, when a curvature portion at the right side in the drawing is held at a position which is displaced by the same distance heading to the optical axis 1b (in a direction perpendicular to the optical axis direction) from an outside diameter of the lens 10, the lens 10 is provided with a step by a gap δ. Therefore, it is preferable that the gap δ is filled with a gap filling material 13 which has a thickness corresponding to a difference of the thickness of the step. Similarly, with regard to the lens 20, a gap filling material 23 is used.

In FIG. 8, for a simple explanation, the difference between the distances of the upper end and the lower end (the gap δ) has been used for the explanation. However, actually as shown in FIG. 1, the holding point is not limited to the maximum point or the minimum point of the lens thickness, and may also be provided at a point of an intermediate thickness. Therefore, it is difficult to determine the thickness of the gap filling member 13. For example, when the thickness of the gap filling member 13 is not exactly the same as the gap difference δ of the lens 10, the lens 10 is obliquely fixed. Therefore, in the present embodiment, it is preferable that a step process is performed on the outer circumference of the lens at a position outside an effective diameter (the light beam effective portion) of the lens 10.

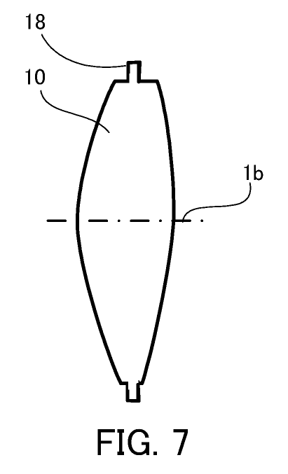

FIG. 7 is a schematic cross-sectional diagram of a lens where a step process has been performed for a lens outer circumference. In FIG. 7, reference numeral 18 denotes a flange portion (a lens flange). The flange portion 18 is provided at the lens outer circumference and has a constant thickness in the optical axis direction. A step surface of the flange portion 18 formed by the step process vertically intersects with the direction of the optical axis 1b, and both surfaces of the flange portion 18 are parallel to each other. In the embodiment, a case of the convex lens has been described, but instead of this, a concave lens can also be applied by adding the similar process.

When such a flange portion 18 is used, the holding point in the vicinity of the outer circumference of the lens 10 has a constant thickness in the direction of the optical axis 1b in any of a circumferential direction even if the outside diameter center 2a of the lens 10 is eccentric with respect to the optical axis 1b (the center 1a of the light beam effective portion 3). Therefore, the tilt which may be generated in setting up the lens 10 can be suppressed.

When the lens 10 is made of a material such as calcium fluoride or quartz, a polarization state is changed by a distortion generated by an external force. FIG. 4 is an explanatory diagram of a polarization generation state of an optical element. In FIG. 4, when a lens 60 (an optical element) is pressed in a pressure applying directions 61a and 61b that are parallel to a traveling direction of light, a birefringence represented by the following expression (2) is generated, where Re is a birefringence amount, t is a thickness of the optical element, C is a photoelastic coefficient, and Δσ is a generated stress.

Re=t·C·Δσ (2)

In other words, when the light having a polarization direction 62 of a linearly polarized light passes through the lens 60, a state of the polarization direction 62 can be ideally maintained. However, a polarization break which changes a local polarization state is generated by the pressure. Therefore, a phase changes by the birefringence amount Re to be light having a polarization state 65.

The largeness of the polarization break is proportional to a pressure in a direction vertical to the optical axis. Therefore, as shown in FIG. 7, in a case where the step process is performed for the lens 10 in order to form the flange portion 18, the level changed to the distortion in the direction of the optical axis 1b is reduced when the weight of the lens 10 is intensively applied to the flange portion 18 at the lens lower portion. Therefore, in a lens having a large curvature, the generation of the polarization break itself can be reduced. When the lens 10 is a concave lens, a large effect can be obtained because the reduction level of the lens weight is large by removing the lens outer circumference.

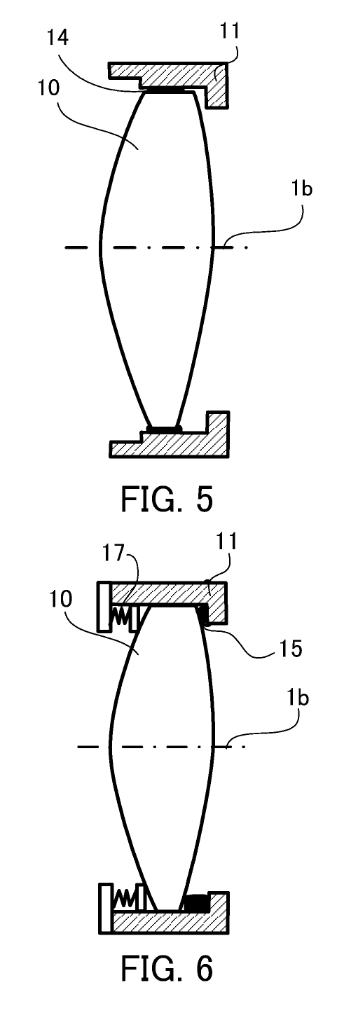

The lens of the present embodiment is not limited to a lens where the step process is performed for its outer circumference. FIG. 5 is a schematic cross-sectional diagram of a lens barrel whose lens outer circumference is adhesively fixed. As shown in FIG. 5, the outer circumference of the lens 10 is adhesively fixed on a lens barrel 11 via adhesive 14. Such a configuration can also effectively suppress the influence caused by the unevenness of the thickness of the lens 10. When the lens 10 is displaced in a rotational direction in the lens barrel 11 by performing an eccentric process for the lens 10, the optical axis 1b of the lens 10 changes in the lens barrel 11. Therefore, a rotational displacement of the lens 10 can be suppressed by performing an orientation flat process or the like at the outer circumference of the lens 10.

The present embodiment has described the case where the optical axis direction of the lens and the direction of the gravitational force are vertical to each other, but is not limited to this. The present embodiment can also be applied to a case where the lens is arranged so that the optical axis direction and the direction of the gravitational force are different.

The present embodiment has described the biconvex lens and the biconcave lens, but is not limited to them and may also use a planoconvex lens, a convex meniscus lens, a concave meniscus lens, a planoconcave lens, or the like. In the planoconvex lens or the planoconcave lens, although one of the lens surfaces is planar, in this case, the curvature center of the lens surface is considered to be at infinity. Further, the present embodiment can be applied to any one of a spherical lens and an aspherical lens.

A device (a semiconductor integrated circuit device, a liquid crystal display device, or the like) is manufactured by a step of exposing a substrate (a wafer, a glass plate, or the like) which is coated by a photosensitizing agent using the exposure apparatus in any one of the above embodiments, a step of developing the substrate, and other well-known steps.

As described above, according to the present embodiment, a lens in which an influence of a polarization break is suppressed can be provided even when the lens is used in a state where an optical axis direction of the lens and the direction of the gravitational force are different. Further, because a barrel of the lens is configured with a small bore, the influence range of the polarization break on a lens surface can be reduced. Thus, according to the present embodiment, a reliable lens and exposure apparatus which suppress a deterioration of an optical performance can be provided. Further, according to the present embodiment, a device manufacturing method which manufactures a high quality device can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-009581, filed on Jan. 20, 2009, which is hereby incorporated by reference herein in its entirety.

What is claimed is:

1. A lens comprising:
a lens surface having a predetermined curvature,
wherein the lens is configured to be used in a state where a direction of an optical axis passing through a curvature center of the lens surface is different from a direction of a gravitational force, and
wherein a position of the optical axis on the lens surface is displaced from a center position of a lens outside diameter on the lens surface.

2. A lens according to claim 1,
wherein in the direction of the optical axis, one of a position where the lens is the thickest and a position where the lens is the thinnest on the lens surface is displaced from the center position of the lens outside diameter on the lens surface.

3. A lens according to claim 1,
wherein the position of the optical axis is displaced in a direction different from the direction of the gravitational force from the center position of the lens outside diameter.

4. A lens according to claim 1, further comprising a flange portion which has a constant thickness in the direction of the optical axis and is provided at an outer circumference portion of the lens.

5. An exposure apparatus which exposes a pattern of an original plate onto a substrate, the exposure apparatus comprising:
an illumination optical system configured to illuminate the original plate using light from a light source; and
a projection optical system configured to project the pattern of the original plate onto the substrate,
wherein the illumination optical system includes a lens which is arranged so that a direction of an optical axis passing through a curvature center of a lens surface is different from a direction of a gravitational force, and
wherein a position of the optical axis on the lens surface is displaced in a direction different from the direction of the gravitational force from a center position of a lens outside diameter on the lens surface.

6. An exposure apparatus according to claim 5,
wherein the illumination optical system includes a fly-eye lens, and
wherein the lens is arranged at an image side with reference to the fly-eye lens.

7. A device manufacturing method comprising the steps of:
exposing a substrate using an exposure apparatus; and
developing the exposed substrate,
wherein the exposure apparatus is configured to expose a pattern of an original plate onto the substrate, the exposure apparatus comprising:
an illumination optical system configured to illuminate the original plate using light from a light source; and
a projection optical system configured to project the pattern of the original plate onto the substrate,
wherein the illumination optical system includes a lens which is arranged so that a direction of an optical axis passing through a curvature center of a lens surface is different from a direction of a gravitational force, and
wherein a position of the optical axis on the lens surface is displaced in a direction different from the direction of the gravitational force from a center position of a lens outside diameter on the lens surface.
